(19) United States
(12) Patent Application Publication
(10) Pub. No.: US 2009/0138786 A1
(43) Pub. Date: May 28, 2009

(54) COMMUNICATION CONTROL APPARATUS, COMMUNICATION CONTROL METHOD, AND COMMUNICATION CONTROL PROGRAM

(75) Inventors: Masatsugu Nishida, Kawasaki (JP); Mamoru Mori, Kawasaki (JP); Katsuhiko Takeuchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/247,011

(22) Filed: Oct. 7, 2008

(30) Foreign Application Priority Data
Nov. 22, 2007 (JP) 2007-303291

(51) Int. Cl. G06F 11/16

(52) U.S. Cl. 714/798; 714/E11.067

(57) ABSTRACT

A communication control apparatus transmits data to an other communication control apparatus and receives a notification as to whether the data has normally been received or not from the other communication control apparatus. The communication control apparatus includes setting changing means for changing setting of a transmission circuit when reception error which is a notification that the data has not normally been received is received from the other communication control apparatus.

### BACKGROUND OF THE INVENTION

1. Field of the Invention

The present communication control apparatus, communication control method, and communication control program relate to a communication control apparatus, a communication control method, and a communication control program for transmitting data to an other communication control apparatus and receiving a notification as to whether the data has normally been received or not from the other communication control apparatus.

2. Description of the Related Art

Presently, as a new disk drive interface, the serial ATA interface (hereinafter, referred to as SATA interface) is becoming predominant. Like the conventional ATA interface (namely, the parallel ATA interface), the SATA interface is used as an interface between a peripheral device typified by a magnetic disk drive and a host (host system) typified by a personal computer.

A device which is a peripheral device having such a SATA interface (for example, a magnetic disk drive [hereinafter, referred to as HDD as required]) is connected to the host (host bus adaptor) by a SATA bus, and communicated to the host in a packet/frame, known as a Frame Information Structure (FIS).

The host has a shadow task file register. By an application accessing this register (for example, issuing a command), a FIS (frame information structure) is issued to the device, and is reflected in the task file register of the device. Then, the device analyzes and processes the reflected command. Moreover, the response to the command from the device is transmitted by a FIS, and is reflected in the shadow task file register of the host.

Moreover, the SATA interface standard defines that a cable of up to 1 m can be used in the data transfer using the SATA interface. Moreover, the Gen1i standard defines that the maximum and minimum levels of the signal amplitude at the receiving end are 600 mV and 325 mV, respectively.

When a device is actually connected by using the SATA interface, data signal attenuation occurs because of the cable (SATA bus). That is, the data signal outputted from the device at the transmitting end is attenuated by the cable (SATA bus) and this decreases the signal amplitude at the receiving end.

Therefore, when the device is connected by a long cable or a low quality transmission line, the amplitude and the signal quality are deteriorated, which can cause a communication error. On the other hand, for example, when the signal amplitude is excessively increased because a low quality transmission line is being used, the above-mentioned SATA interface standard is exceeded, which can damage the device at the other end.

Since what transmission line is used for connection is unknown as mentioned above, a fixed parameter set at the starting time must be used. Therefore, as shown in FIG. 13, when the device receives R_ERR from the host, the device retries two or more times. However, the possibility of relief is extremely low since a fixed parameter is used.

For this reason, Patent Document 1 (Japanese Unexamined Patent Application Publication No. 2005-50257) discloses a method in which the amplitude of the reception signal of a port is compared with a standard and the amplitude of the transmission signal of the port is manipulated. That is, the amplitude of the transmission signal is controlled according to the level of the reception signal system.

A method is also known in which communication is performed between the receiving end and the transmitting end to adjust the output signal level. Specifically, the receiving end measures the quality of the reception signal, and based on the result, transmits correction request data to the transmitting end. Then, the transmitting end corrects the setting of the transmission output according to the received correction request data.

According to the above-described technology of Patent Document 1, it is assumed that the amplitude of both ports is same. For example, if the amplitude of host is higher than the standard, the device decreases its own level even though it is lower than the standard. Consequently, stable communication cannot be performed, and the system lacks reliability.

Moreover, according to the above-described method in which communication is performed between the receiving end and the transmitting end to adjust the output signal level, since the correction request data for adjusting the output signal level is transmitted and received, it is necessary to extend the standard of the correction request data both at the transmitting end and at the receiving end.

Accordingly, a communication control apparatus, a communication control method, and a communication control program according to the present embodiment are made to solve the above-mentioned problems of the related art, and an object thereof is to perform stable communication without extending the standard of the interface and improve the system reliability.

### SUMMARY

In accordance with an aspect of embodiments, a communication control apparatus transmits data to an other communication control apparatus and receives a notification as to whether the data has normally been received or not from the other communication control apparatus. The communication control apparatus includes setting changing means for changing the setting of a transmission circuit when a reception error, which is a notification that the data has not normally been received, is received from the other communication control apparatus.

### BRIEF DESCRIPTION OF THE DRAWINGS

FIG. 1 is a view for explaining the general outline and characteristic of a communication system according to a first embodiment;

FIG. 2 is a block diagram showing the serial ATA communication layer of the communication system 1 according to the first embodiment;

FIG. 3 is a view for explaining the structure of frame data;

FIG. 4 is a view for explaining an example of frame transfer control;

FIG. 5 is a block diagram showing the structure of a device according to the first embodiment;

FIG. 6 is a view for explaining an example of an amplitude setting register held by the device according to the first embodiment;

FIG. 7 is a flowchart showing the processing operation of the device according to the first embodiment;

FIG. 8 is a flowchart showing the processing procedure of a device according to a second embodiment;

FIG. 9 is a view for explaining an example of a setting register held by a device according to a third embodiment;

FIG. 10 is a flowchart showing the processing operation of the device according to the third embodiment;

FIG. 11 is a view for explaining an example of a setting register held by a device according to a fourth embodiment;

FIG. 12 is a view showing a computer that executes a communication control program; and

FIG. 13 is a view for explaining the related art.

### DETAILED DESCRIPTION OF THE EMBODIMENTS

Hereinafter, embodiments of a communication control apparatus, a communication control method, and a communication control program according to the present communication control apparatus, communication control method and communication control program will be described in detail with reference to the attached drawings.

### First Embodiment

In the following embodiment, the general outline and characteristic of a communication system according to a first embodiment and the structure and processing flow of the communication system will be described in succession, and lastly, the effects of the first embodiment will be described. In the following, an example of a communication system, in which the motherboard (hereinafter, referred to as host) and the magnetic disk drive (hereinafter, referred to as device) transmit and receive the frame data with Serial ATA interface, will be described.

(General Outline and Characteristic of the Communication System According to the First Embodiment)

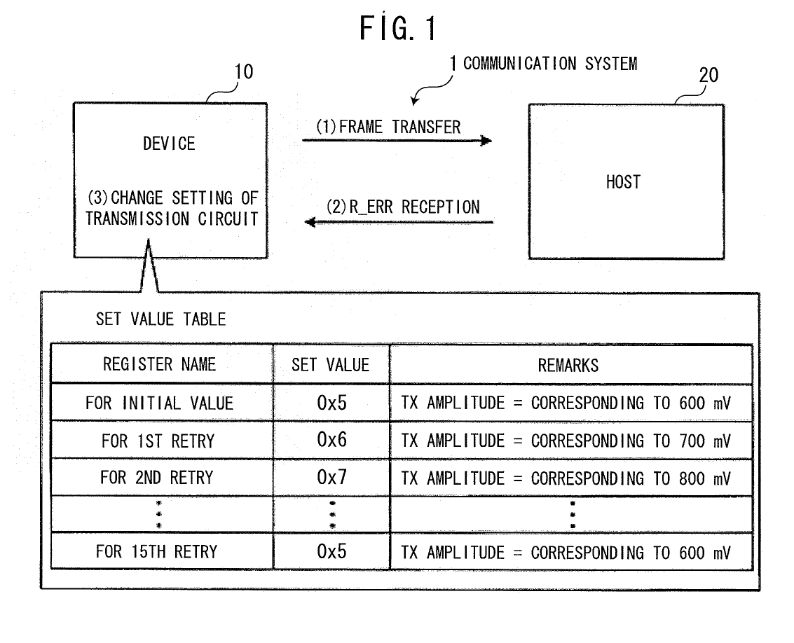

Firstly, using FIG. 1, the general outline and characteristic of the communication system according to the first embodiment will be described. FIG. 1 is a view for explaining the general outline and characteristic of the communication system according to the first embodiment.

In the communication system 1 of the first embodiment, the general outline is that a device 10 transmits data to a host 20 and receives a notification as to whether the data has correctly been received or not from the host 20. A principal characteristic of the device 10 is that the system reliability is improved. While an example in which the device 10 is the transmitting end and the host 20 is the receiving side will be described in the following, the host may be the transmitting end and the device may be the receiving end.

Concretely describing this principal characteristic, the communication system 1 includes the device 10 that transmits frames to the host 20 and the host 20 that receives frames from the device 10. The device 10 and the host 20 are connected through a SATA cable.

In this structure, the device 10 of the communication system 1 transmits a frame transmission request (X_RDY) to the host 20, and then, performs frame transfer (see (1) of FIG. 1). Specifically, the device 10 transmits the frame transmission request (X_RDY) to the host 20. Then, the host 20 having received the frame transmission request returns a transmission permission (R_RDY) to the device 10 when it becomes ready for reception.

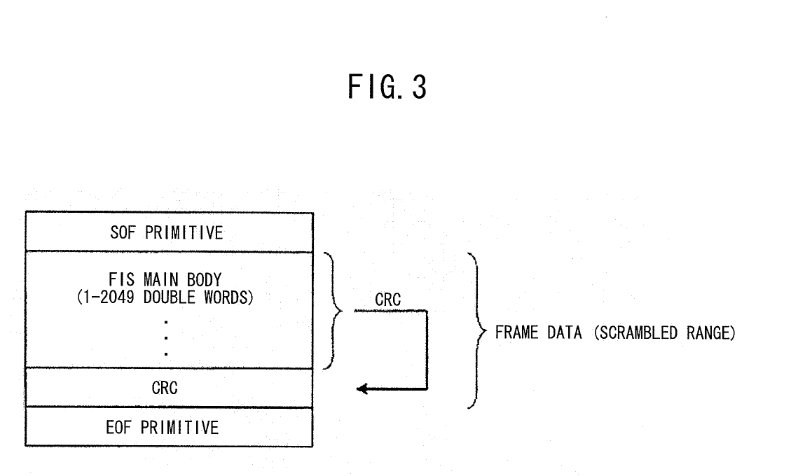

Then, the device 10 having received the transmission permission transfers a frame from SOF to EOF (described later, see FIG. 3). Then, after the transfer is finished, the device 10 waits for the reception result from the host while outputting a WTERM primitive. During the reception, the host 20 outputs an R_IP primitive representing that reception is in progress, and if there is no problem with the received frame, the host 20 transmits R_OK to the device 10. If there is a problem with the received frame, the host 20 transmits reception error (R_ERR) to the device 10 (see (2) of FIG. 1).

Then, when the reception error is returned from the host 20, the device 10 changes the setting of the transmission circuit (see (3) of FIG. 1). For example, when the reception error (R_ERR) is received, the device 10 sets a transmission error status bit, and makes a transition into idle state. When the transmission error status bit has been set, the device 10 changes the TX amplitude parameter during the transmission of Align primitive. Align primitive is a control code used for clock-resynchronization of the serial ATA interface. In that case, the device 10 clears the transmission error status bit.

Then, the device 10 requests frame transmission again, and performs retry. In the example of FIG. 1, the set value table contains a set value “for the fifteenth retry”, and retry is performed up to fifteen times. When R_ERR is returned even at the fifteenth retry, an interrupt is applied, and the processing is returned to the firmware.

As described above, in the communication system 1, since the setting of the transmission circuit is changed when the reception error is received like the above-described principal characteristic, stable communication can be performed without extending the standard of interface and irrespective of the quality of the transmission system, and the system reliability can be improved.

(Communication Hierarchy of the Communication System)

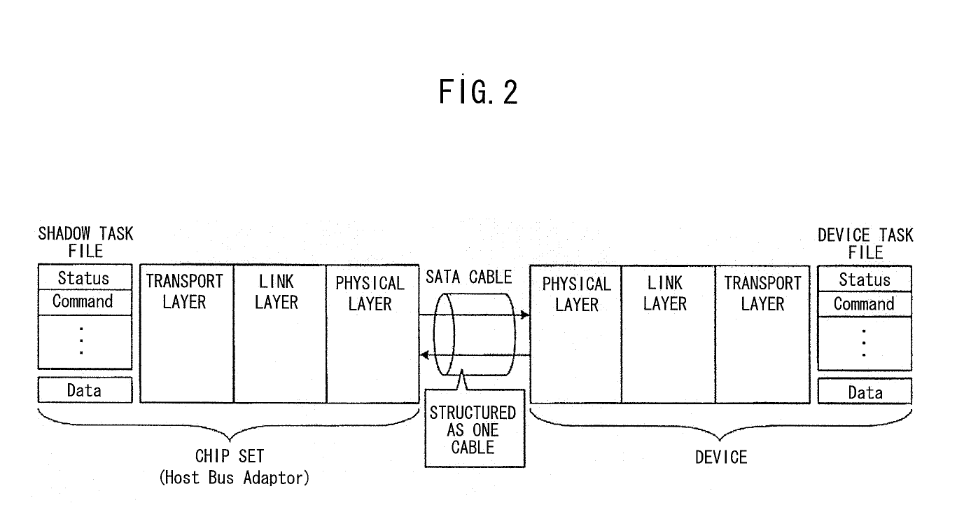

Next, using FIG. 2, the serial ATA communication layer in the communication system 1 shown in FIG. 1 will be described. FIG. 2 is a block diagram showing the serial ATA communication layer of the communication system 1 according to the first embodiment.

As shown in FIG. 2, There are four layers in the Serial ATA architecture: Application, Transport, Link, and Phy. The physical layer has the function of performing high-speed serial data transfer (transmission and reception) through the serial ATA bus, and receives and outputs serial data signals.

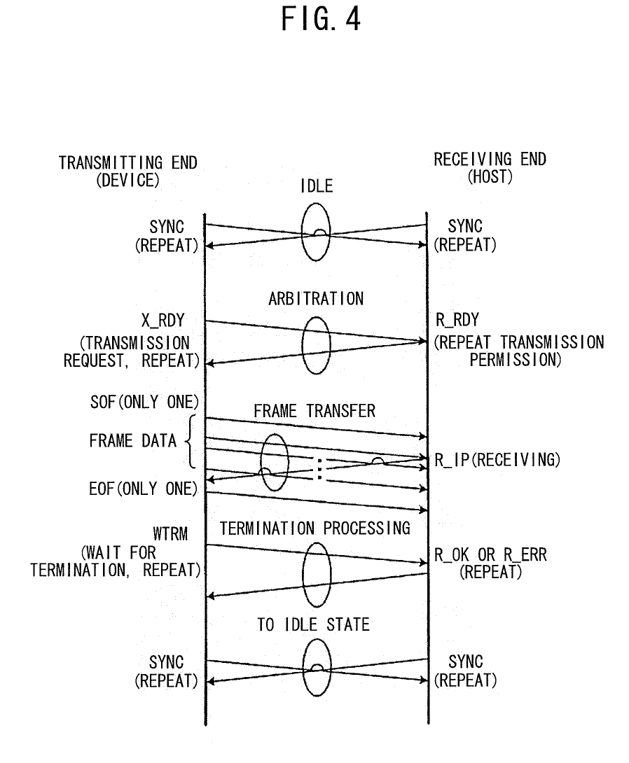

The frame transfer control will be described by using FIGS. 3 and 4. As shown in FIG. 3, the transfer control of the link layer is performed by a control code called primitive. The primitive is data of one double word (four bytes), and is formed of a control code called K28.3 or K28.5 (first byte) and a three-byte data code.

The link layer calculates the Cyclic Redundancy Check (CRC) of the frame data sent from the transport layer, and adds it to the end of the frame data so as to be sandwiched between the start-of-field (SOF) primitive and the end-of-field (EOF) primitive. Then, the link layer encodes the frame data using 8b/10b, and sends it to the physical layer.

Using the example of FIG. 4, a simple example of the transfer control will be described. As shown in FIG. 4, before the device 10 transmit frame data, the link layer of the device transmits a transmission request (X_RDY primitive) to the host 20 as arbitration, and obtains a transmission permission (R_RDY primitive) from the host 20.

Then, the device 10 transmits the above-mentioned SOF to EOF to the host 20. Then, the device 10 waits for the transmission status of the host 10 as the receiving end while transmitting WTRM. If the host correctly receives the frame data, the host 20 returns R_OK to the device 10, but if the host can't correctly receive the frame data, the host 20 returns R_ERR to the device 10. When the reception error (R_ERR) is received, the device 10 changes the TX amplitude parameter, requests frame transmission again, and performs retry.

In the serial ATA, since the frequency of the clock source at the transmitting end and that of the clock source at the receiving end are not completely the same, the reception clock is generated while the difference is corrected. Moreover, since the clock phase is shifted after the elapse of a long time, according to the SATA interface standard, at least two pairs (two double words) of ALIGN primitives should be transferred every 256 double words, and the phase correction can be performed.

(Structure of the Device)

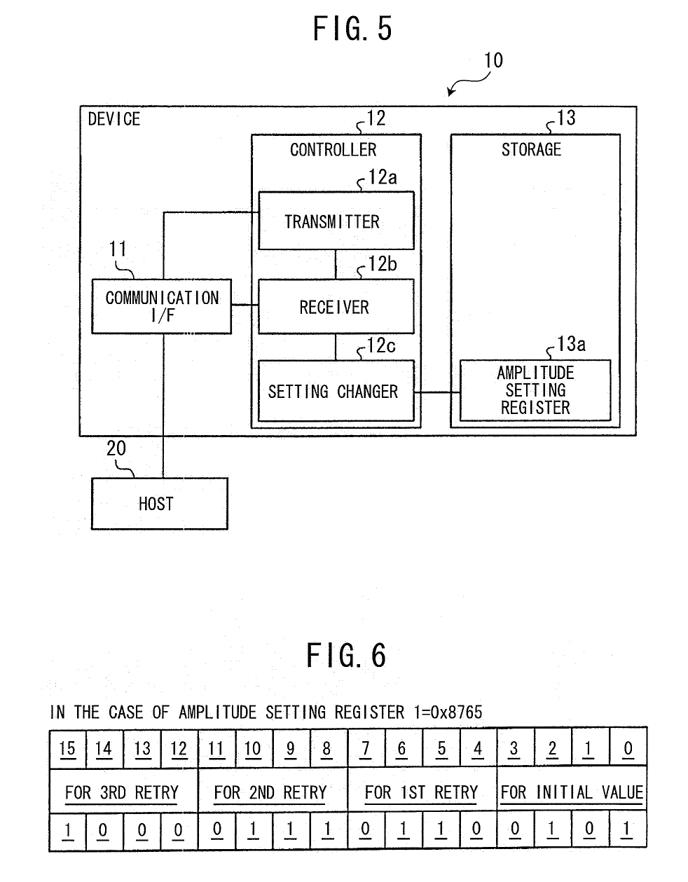

Next, using FIG. 5, the structure of the device 10 shown in FIG. 1 will be described. FIG. 5 is a block diagram showing the structure of the device 10 according to the first embodiment. As shown in FIG. 5, the device 10 includes a communication I/F 11, a controller 12, and a memory 13, and is connected to the host 20 through the SATA cable. The processings of these elements will be described.

The communication I/F 11 controls communication related to various pieces of information exchanged with the host 20 to which the device 10 is connected. Specifically, the communication I/F 11 transmits the frame transmission request (X_RDY) and frame data to the host 20, and receives the transmission permission (R_RDY) and the reception error (R_ERR) from the host 20. The communication I/F 11 is a connector for the serial ATA cable.

The memory 13 stores data and programs necessary for various processings by the controller 12. As an element particularly closely associated with the present invention, the memory 13 has an amplitude setting register 13a for setting the amplitude.

In the amplitude setting register 13a including four 16-bit registers, TX amplitude values corresponding to the fields of the registers, respectively, are set. These set values are referred to by a setting changer 12c described later when the reception error is returned from the host 20. Specifically, the amplitude setting register 13a is defined as “for the initial value”, “for the first retry”, “for the second retry”, . . . in the fields of every four bits, respectively, and values of 0h to Fh to control the amplitude of the TX signal of the device 10 are set.

The value corresponding to each field of each register is set to amplitude setting register 13a. For example, in one of the amplitude setting register 13a, predetermined values are set like 0x5 (0101b) as the initial value, 0x6 for the first retry, 0x7 for the second retry, . . . as illustrated in FIG. 6. There are three registers besides FIG. 6 in the amplitude setting register 13a.

While the amplitude setting register 13a has 16 fields to set the value corresponding to the amplitude, it is not the necessary condition.

The controller 12 has an internal memory for storing programs defining various processing procedures and necessary data, and performs various processings thereby. As elements particularly closely associated with the present invention, the controller 12 has a transmitter 12a, a receiver 12b, and the setting changer 12c. The setting changer 12c corresponds to the “setting changing means” as claimed in the claims.

The transmitter 12a transmits serial data to the host 20 through the SATA cable. Specifically, the transmitter 12a transmits the frame transmission request (X_RDY) and frame data to the host 20. The receiver 12b receives serial data from the host 20 through the SATA cable. Specifically, when the transmission permission (R_RDY) and the reception error (R_ERR) are received from the host 20 and the reception error (R_ERR) and the reception normal (R_OK) are received, the receiver 12b notifies the setting changer 12c of the reception.

The setting changer 12c changes the setting of the transmission circuit when the reception error is returned from the host 20. Specifically, when information on the reception of the reception error (R_ERR) is received from the receiver 12b, the setting changer 12c sets the transmission error status bit, and link layer makes a transition into idle state. Then, the setting changer 12c increments the counter value by one, and determines whether the counter value “N” is less than 16 or not. When the counter value “N” is not less than 16, the setting changer 12c applies an interrupt, and returns the processing to the firmware.

When the counter value “N” is less than 16, the setting changer 12c changes the TX amplitude parameter with reference to the amplitude setting register 13a corresponding to the value of the retry counter during the transmission of ALIGN primitive on condition that the transmission error status bit has been set. In that case, the setting changer 12c clears the transmission error status bit. Then, the transmitter 12a requests frame transmission again, and performs retry.

The reason why the setting is changed during the transmission of the Align primitive is that the reception of Align primitive is meaningless in the link layer. Therefore, even though noise is caused by the switching of the setting at this timing, communication is unaffected Two pairs of ALIGN primitive is usually transmitted every 256 double words. However, if the period to change the setting is insufficient in two ALIGN primitive transmissions, you may increase the number of ALIGN primitive transmissions. While the timing is not limited to the timing of transmission of the Align primitive, if the setting is changed at a timing of transmission of other than the Align primitive, there is a possibility that noise or offset will be caused in the bit stream and the host may not be able to receive frame data correctly.

(Processing by the Device)

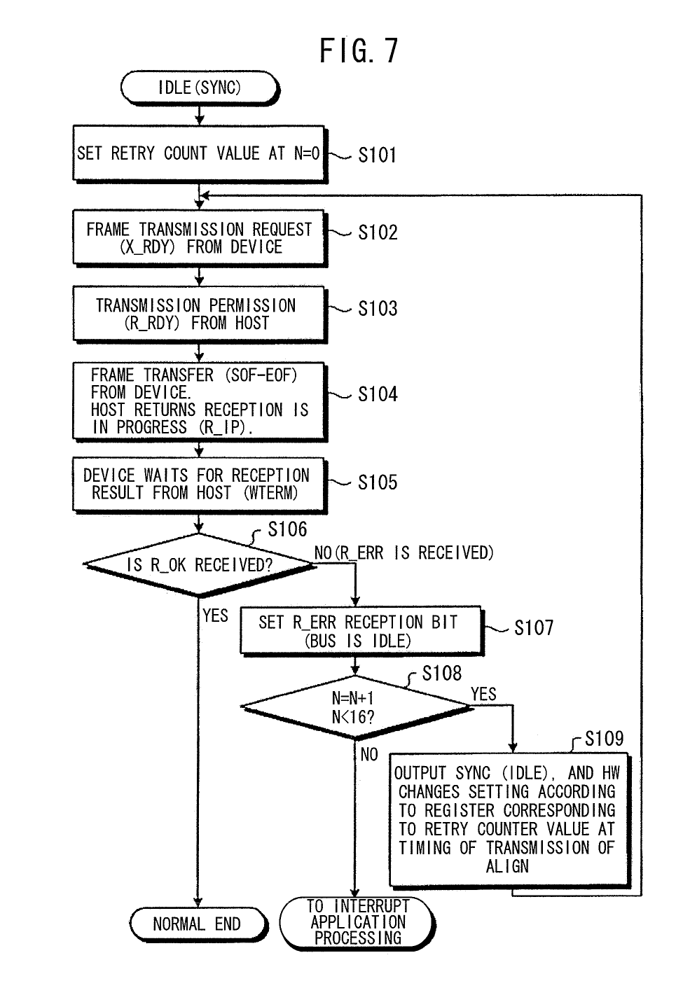

Next, using FIG. 7, the processing by the device 10 according to the first embodiment will be described. FIG. 7 is a flowchart showing the processing operation of the device 10 according to the first embodiment.

As shown in FIG. 7, the device 10 sets the retry counter value “N” at the initial value “0” (the TX amplitude parameter=0x5) (step S101), and then, transmits the frame transmission request (X_RDY) to the host 20 (step S102). When the transmission permission (R_RDY) is received from the host 20 (step S103), the device 10 transfers frames from SOF to EOF (step S104). Then, after the transfer is finished, the device 10 waits for the reception result from the host while outputting the WTERM primitive (step S105).

Then, the device 10 determines whether the reception normal (R_OK) is received or not (step S106). When the reception normal (R_OK) is received (step S106, Yes), the device 10 ends the processing normally. When the reception error (R_ERR) is received (step S106, No), the device 10 makes a transition to idle state, and sets the transmission error status bit (step S107). Then, the device 10 increments the counter value by one, and determines whether the counter value “N” is less than 16 or not (step S108). When the counter value “N” is not less than 16 (step S108, No), the device 10 applies an interrupt, and returns the processing to the firmware.

When the counter value “N” is less than 16 (step S108, Yes), the device 10 changes the TX amplitude parameter with reference to the amplitude setting register corresponding to the value of the retry counter during the transmission of Align primitive on condition that the transmission error status bit has been set (step S109). In that case, the device 10 clears the transmission error status bit. Then, returning to S102, the device 10 requests frame transmission again, and performs retry.

(Effects of the First Embodiment)

As described above, in the communication system 1, since the setting of the transmission circuit is changed when the reception error is received, stable communication can be performed without extending the standard of interface and irrespective of the quality of the transmission system, and the system reliability can be improved.

Moreover, according to the first embodiment, when the setting is changed while transmitting data, it is possible to cause further errors by a discontinuous offset fluctuation and the timing fluctuation. For this reason, The setting is changed during the transmission of the ALIGN primitive that doesn't affect communications. As a result, the setting can be reflected without influencing communications.

### Second Embodiment

While a case where the device has sixteen 4-bit fields to control the amplitude of the TX signal is described in the first embodiment, the present invention is not limited thereto. The number of 4-bit fields, to control the amplitude of the TX signal, provided in the device may be one.

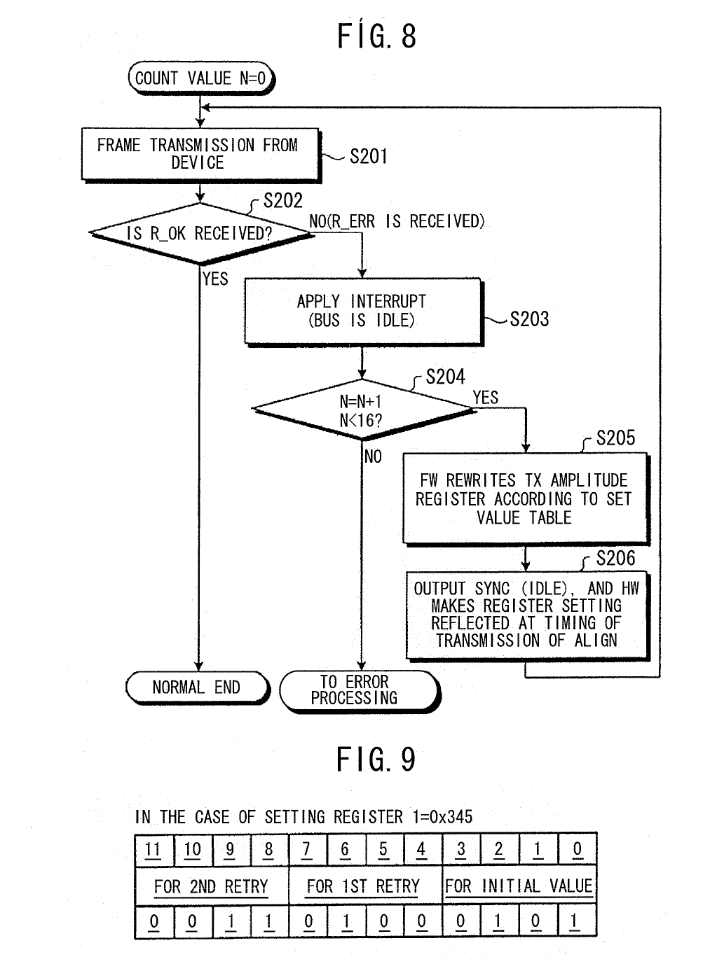

In the following second embodiment, using FIG. 8, the processing of a device 10 according to the second embodiment will be described as a case where the device 10 has one register to control the amplitude of the TX signal, the initial value is 0x5 (0101b) and the firmware has, in the memory 13, a retry table storing predetermined set values like the set value for the first retry “0x6”, the set value for the second retry “0x7”, . . . . FIG. 8 is a flowchart showing the processing procedure of the device according to the second embodiment.

As shown in FIG. 8, in the device 10 according to the second embodiment, frame transmission to the host 20 is performed (step S201). When R_ERR is received from the host (step S202, No), an interrupt is applied, and the processing is shifted to the firmware (step S203). Then, the device 10 increments the counter value by one, and determines whether the counter value “N” is less than 16 or not (step S204). When the counter value “N” is not less than 16 (step S204, No), the device 10 performs error processing.

Moreover, in the device 10, when the counter value “N” is less than 16 (step S204, Yes), the firmware rewrites the TX amplitude parameter into the register according to the counter value and the retry table (step S205). That is, for example, when the retry value is “N=1”, it is determined that the retry is the first retry, the TX amplitude parameter of the set value “0x6” corresponding to the retry table is rewritten into the register.

The setting is not immediately reflected but is made reflected during the transmission of the ALIGN primitive by the hardware (step S206). While a case where the device has a retry table is described in the above, a structure may be adopted in which the set value is obtained by a calculation formula instead of a retry table.

As described above, according to the second embodiment, since the setting of the transmission circuit is changed by hardware after the set value of the register is rewritten by the firmware when the reception error is received, stable communication is performed without extending the standard of the interface by a single register, and the system reliability can be improved.

### Third Embodiment

While a case where when the device is the transmitting end and receives R_ERR, the parameter of the device as the transmitting end is changed is described in the first embodiment, the present invention is not limited thereto. A structure may be adopted in which when the device is the receiving end and transmits R_ERR, the parameter of the device as the receiving end is changed. Since whether the host as the transmitting end performs retry or not is unclear when the device as the receiving end changes the parameter, the following description is given on the assumption that the host performs retry.

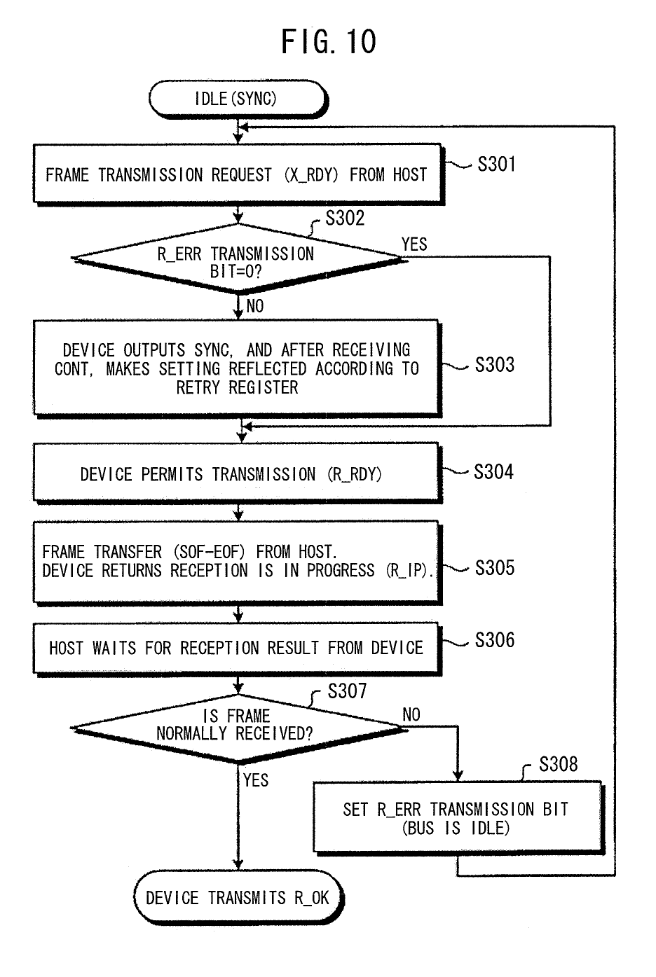

Accordingly, in the following third embodiment, using FIGS. 9 and 10, the structure and processing of a device according to the third embodiment will be described as a case where when R_ERR is transmitted, the parameter of the device 10 as the receiving end is changed. FIG. 9 is a register of detection threshold of the device 10b according to the third embodiment. FIG. 10 is a flowchart showing the processing procedure of the device 10b according to the third embodiment.

As shown in FIG. 9, the device 10b according to the third embodiment has a register having three 4-bit fields to control the threshold of the RX signal. This threshold is a setting to ignore a lower signal than the set amplitude. For example, in the register, predetermined threshold values are set like 0x5 (0101b) as the initial value, 0x4 for the first retry, and 0x3 for the second retry.

For example, as shown in FIG. 9, predetermined values are set like 200 mV (the setting value=0101b) as the default, 175 mV (the setting value=1000b) for the first retry, and 150 mV (the setting value=0011b) for the second retry. While the number of registers is three and retry is accepted without any involvement by the firmware in this example, a structure may be adopted in which the number of registers is only one for the initial value, a retry table storing the predetermined set values of the threshold is provided in the memory 13, an interrupt is applied every occurrence of reception error, the value of the threshold corresponding to the retry table is rewritten into the RX threshold setting register by the firmware, and retry is accepted.

Next, the processing procedure of the device 10b according to the third embodiment will be described. As shown in FIG. 10, the device 10b receives the frame transmission request (X_RDY) transmitted by the host 20 (step S301). Then, the device 10b determines whether the R_ERR transmission bit is “0” or not (step S302). When the R_ERR transmission bit is “1” (step S302, No), the device 10b changes the RX threshold setting to the value set in the retry register during the reception of CONT primitive from the host. For example, at the first retry, the device 10b changes the RX threshold setting to 175 mV set in the register for the first retry. In that case, the device 10b clears the reception error status bit (step S303).

Thereafter, when the frame transmission request (X_RDY) is sent from the host 20, the device 10b issues the frame transmission permission (R_RDY), and receives the data from the host 20 (step S304). Any repetitive primitive may be implied to continue repeating through the use of CONT primitive. For example, when idle state is continued, the CONT primitive is transmitted after SYNC primitive, and subsequently, scrambled arbitrary data (JUNK) is transmitted.

Then, the device 10b returns the transmission permission (R_RDY) to the host 20 (step S304). The host 20 transfers a frame from SOF to EOF (step S305). Then, after the transfer is finished, the host 20 waits for the reception result from the device 10b while outputting the WTERM primitive (step S306). During the reception, the device 10b outputs the R_IP primitive representing that reception is in progress, and determines whether the frame is correctly received or not (step S307). When the device 10 receives correctly the frame (step S307, Yes), the device 10b transmits R_OK to the host 20.

When the device 10 can not correctly receive the frame (step S307, No), the device 10b transmits R_ERR, and sets the R_ERR bit to “1” (step S308). Then, the device 10b transmits the SYNC primitive, makes a transition into idle state, and returns to step S302. That is, when the device 10 can not correctly receive the frame, the device 10b sequentially changes the setting whenever the host 20 makes a retry request.

While the device changes the setting during the reception of CONT primitive that means idle state in the flow of FIG. 10, the present invention is not specifically limited thereto. While the parameter changed at retry is the threshold setting parameter as the parameter at the receiving end, the response characteristic of the PLL or the setting of the equalizer or the like may be changed. That is, by changing the characteristic of the loop filter and the setting of the dumping factor, an error that is caused due to the low signal level can be prevented from occurring.

As described above, according to the third embodiment, by changing the setting of the reception circuit at the receiving end, stable communication is performed without extending the standard of interface, and the system reliability can be improved.

### Fourth Embodiment

While embodiments of the present invention have been described, the present invention may be carried out in various modes in addition to the above-described embodiments. Accordingly, another embodiment included in the present invention will be described as a fourth embodiment.

((1) Setting Register)

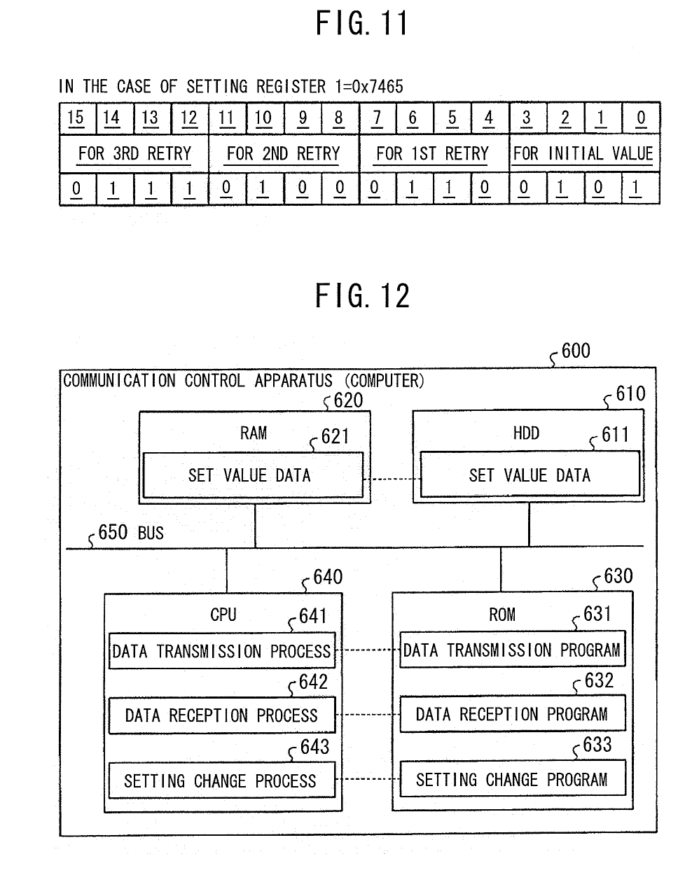

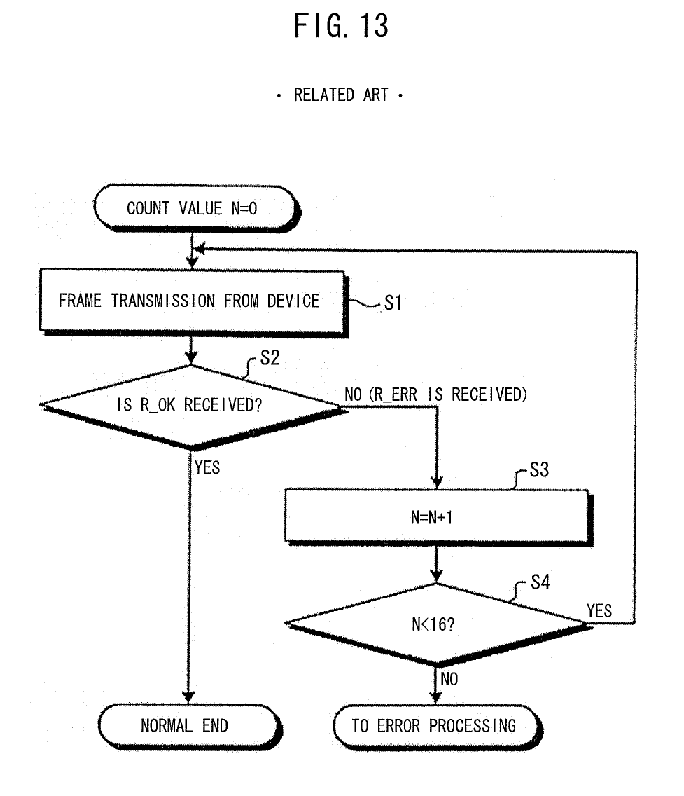

While a case where the value of the TX amplitude increases as retry is repeated is described in the first embodiment, the present invention is not limited thereto. As illustrated in FIG. 11, the setting may be made so that with the initial value as the reference, set values to increase the value of the TX amplitude and set values to decrease it are arranged alternately.

It's effective to enlarge the TX amplitude when the attenuation of the data signal is caused by the transmission line of a long cable or a low quality, and it's effective to decrease the TX amplitude when the communication error is caused by jitter. Consequently, stable communication can be performed.

((2) Setting of the Transmission Circuit)

While a case where the amplitude parameter of the TX output signal is changed at retry is described in the first embodiment, in the present invention, the present invention is not limited thereto. the setting of the transmission circuit may be changed at the timing of transmission of data for correcting a phase with respect to another communication control apparatus. The preemphasis parameter or the slew rate parameter as the setting of the transmission circuit may be changed.

((3) System Structure, etc.)

The elements of the illustrated devices are functionally conceptual, and it is not always necessary that they be physically structured as illustrated. That is, concrete modes of the disintegration or integration of the devices are not limited to the illustrated ones, and all or some of them may be functionally or physically disintegrated or integrated in given units according to various loads and use conditions. For example, the receiver 12b and the setting changer 12c may be integrated. Further, all or given ones of the processing functions performed by the devices may be realized by a CPU and a program analyzed and executed by the CPU or may be realized as wired logic hardware.

Of the processings described in the embodiments, all or some of the processings described as automatically performed processings may be manually performed, or all or some of the processings described as manually performed processings may be automatically performed by a known method. In addition thereto, the processing procedures, control procedures, concrete names, and information including various pieces of data and parameters shown in the above description and the drawings may be arbitrarily changed except when specified otherwise.

((4) Program)

The processings described in the above embodiments may be realized by executing a prepared program by a computer. Accordingly, using FIG. 12, an example of a computer that executes a program having a function similar to that of the above-described embodiments will be described. FIG. 12 is a view showing a computer that executes a communication control program.

As shown in FIG. 12, a computer 600 as a communication controller includes an HDD 610, a RAM 620, a ROM 630, and a CPU 640 that are connected by a bus 650.

The ROM 630 prestores communication control programs that deliver functions similar to those of the above-described embodiments, that is, as shown in FIG. 12, a data transmission program 631, a data reception program 632, and a setting change program 633. The programs 631 to 633 may be integrated or disintegrated as appropriate similarly to the elements of the device 10 shown in FIG. 5.

By the CPU 640 reading the programs 631 to 633 from the ROM 630 and executing them, as shown in FIG. 12, the programs 631 to 633 function as a data transmission process 641, a data reception process 642, and a setting change process 643, respectively. The processes 641 to 643 correspond to the transmitter 12a, the receiver 12b, and the setting changer 12c shown in FIG. 5, respectively.

The HDD 610 has a set value table 611 as shown in FIG. 12. The CPU 640 registers data into the set value table 611, reads set value data 621 from the set value table 611, stores it into the RAM 620, and performs the processing based on the set value data 621 stored in the RAM 620.

In addition to variations and modifications in the component parts and/or arrangements, alternative uses will also be apparent to those skilled in the art.

What is claimed is:

1. A communication control apparatus for transmitting data to an other communication control apparatus and receiving a notification as to whether the data has normally been received or not from the other communication control apparatus,
the communication control apparatus comprising setting changing means for changing setting of a transmission circuit when a reception error which is a notification that the data has not normally been received is received from the other communication control apparatus.

2. The communication control apparatus according to claim 1, wherein when the reception error is received, the setting of the transmission circuit is changed by performing control so that a set value of a register to control the setting of the transmission circuit is rewritten by firmware.

3. The communication control apparatus according to claim 1, further comprising a set value storing means for associating a value for the setting of the transmission circuit with each of a plurality of registers that control the setting of the transmission circuit, and storing, in a predetermined memory, an order in which the registers control the setting of the transmission circuit, wherein when the reception error is received, the setting changing means changes the setting of the transmission circuit according to the order of the registers stored in the predetermined memory.

4. The communication control apparatus according to claim 1, wherein the setting changing means changes at least one of an amplitude, a preemphasis amount, and a slew rate amount as the setting of the transmission circuit.

5. The communication control apparatus according to claim 4, wherein the setting changing means changes the setting of the transmission circuit at a timing of transmission of data for correcting a phase with respect to the other communication control apparatus.

6. The communication control apparatus according to claim 4, wherein when the reception error is received, the setting of the transmission circuit is changed by performing control so that a set value of a register to control the setting of the transmission circuit is rewritten by firmware.

7. The communication control apparatus according to claim 4, further comprising a set value storing means for associating a value for the setting of the transmission circuit with each of a plurality of registers that control the setting of the transmission circuit, and storing, in a predetermined memory, an order in which the registers control the setting of the transmission circuit, wherein when the reception error is received, the setting changing means changes the setting of the transmission circuit according to the order of the registers stored in the predetermined memory.

8. The communication control apparatus according to claim 1, wherein the setting changing means changes the setting of the transmission circuit at a timing of transmission of data for correcting a phase with respect to the other communication control apparatus.

9. The communication control apparatus according to claim 8, further comprising a set value storing means for associating a value for the setting of the transmission circuit with each of a plurality of registers that control the setting of the transmission circuit, and storing, in a predetermined memory, an order in which the registers control the setting of the transmission circuit, wherein when the reception error is received, the setting changing means changes the setting of the transmission circuit according to the order of the registers stored in the predetermined memory.

10. A communication control method for transmitting data to an other communication control apparatus and receiving a notification as to whether the data has normally been received or not from the other communication control apparatus,
the communication control apparatus comprising a setting changing step of changing setting of a transmission circuit when a reception error which is a notification that the data has not normally been received is received from the other communication control apparatus.
